(19) United States
(12) Patent Application Publication
(10) Pub. No.: US 2026/0188992 A1
(43) Pub. Date: Jul. 2, 2026

(54) ADAPTER FOR USE IN INFORMATION TRANSFER FROM WITHIN SEALED SPACE WITH HAZARDOUS ENVIRONMENT

(71) Applicant: The United States of America, as represented by the Secretary of the Navy, Crane, IN (US)

(72) Inventors: Stephen Miller, Nottingham, NH (US); Michael Sirois, Northwood, NH (US)

(73) Assignee: The United States of America, as represented by the Secretary of the Navy, Arlington, VA (US)

(21) Appl. No.: 19/434,859

(22) Filed: Dec. 29, 2025

Related U.S. Application Data
(60) Provisional application No. 63/739,808, filed on Dec. 30, 2024.

(51) Int. Cl. H02G 15/013; F16L 15/04; H02G 3/22; H02G 15/007; H02G 15/08

(52) U.S. Cl. CPC H02G 15/013; F16L 15/04; H02G 3/22; H02G 15/007; H02G 15/08

(57) ABSTRACT

Disclosed is an adaptor for use in preventing environment from escaping from an isolated area to an open area while providing a means to transfer data/information and services to the isolated space such within a ship/vessel. The adaptor includes a body having a first inner bore section extending centrally through the body and having threads configured for securement to an existing penetration of the closed space. The body also includes a threaded collar assembly extending centrally through the body such that first and second inner bore sections are axially aligned and allow passage of a communication cable and service pipe through the body. Additionally, inserts are disposed within the threaded collar and configured with cylindrical bores extending centrally through the insert and configured to allow the communication cable to be extended therethrough and fixedly secure the communication cable to prevent movement of the communication cable and provide strain relief.

### CROSS-REFERENCE TO RELATED APPLICATIONS

The present application claims priority to and the benefit of U.S. Provisional Patent Application Ser. No. 63/739,808 filed Dec. 30, 2024, and entitled “ADAPTER FOR USE IN INFORMATION TRANSFER IN VESSELS,” the disclosure of which is expressly incorporated by reference herein.

### STATEMENT REGARDING FEDERALLY SPONSORED RESEARCH OR DEVELOPMENT

The present invention described herein was made in the performance of official duties by employees of the Department of the Navy and may be manufactured, used and licensed by or for the United States Government for any governmental purpose without payment of any royalties thereon. This invention (Navy Case 212416US02) is assigned to the United States Government and is available for licensing for commercial purposes. Licensing and technical inquiries may be directed to the Technology Transfer Office, Portsmouth Naval Shipyard (PNSY), email: Sarah Buttrick at sarah.d.buttrick.civ@us.navy.mil or Jessica Forbus at Jessica.l.forbus.civ@us.navy.mil.

### FIELD

The present disclosure generally relates to an apparatus affording transfer of digital information as well as services such as water from an isolated or closed environment space or area within a vessel (or a portion of a vessel) while containing a potentially hazardous environment (such as that generated during a refrigerant leak or fire) to an unaffected area. In particular, the present disclosure relates to an adapter that affords the ability to pass digital information and services through an extant penetration, aperture, or opening from an isolated environment space to an environment that is not isolated without leakage from the closed environment.

### BACKGROUND

In certain environments such as in those that occur on ships, situations may arise where the vessel or a portion thereof needs to be kept in a high state of integrity (e.g., sealed with no leakage), such as following establishment of a hazardous environment (such as a refrigerant leak or fire). In these situations, typically all apertures or penetrations where the closed environment exists (e.g., hatches or valves) are shut or maintained in a sealed state. In the case of a vessel, for example, this sealing prevents the uncertain compounds (such as those generated during a refrigerant leak or fire) from transferring from an isolated area to an outside space. Furthermore, vessels have a few penetrations, openings, or apertures, and there is very strict control of those penetrations, openings, or apertures. Moreover, in specific environments it is beneficial for personnel to access live data (e.g., digital communication data) from equipment within the sealed space or to provide services (such as water) to the sealed space. Since the penetrations are few and are tightly controlled, however, this makes design of means to allow digital communications via a wired connection or providing services (such as water) extremely difficult, as well time consuming, costly, and cumbersome to implement.

It is noted that technologies utilizing ultrasonic transmitters and receivers provide an alternative to using an existing hull penetration. These technologies, however, are still in a research phase and the costs of an ultrasonic assembly are quite significant and take a lengthy period of time to install. Additionally, these technologies do not provide other services such as water, for example.

Accordingly, there is a need for an apparatus or assembly affording transfer of signal information out of sealed spaces as well as provide other services (e.g., water) to such sealed spaces that is quick to install and remove with minimal retest along with lower cost.

### SUMMARY

According to one aspect, the present disclosure provides an adaptor for use in a

sealed environmental space while providing information transfer from the environmental space and provide other services (e.g., water) to the environmental space. The adaptor includes a body comprising a first inner bore section and having threads configured for securement to an existing penetration of the sealed space. The body also includes a second threaded inner bore section extending centrally through the body such that first and second inner bore sections are axially aligned and allow passage of a communication cable and water pipe through the body. Moreover, the body includes inserts disposed within the second inner bore section, the insert further configured with a cylindrical bore extending centrally through the insert and configured to allow the communication cable and water pipe to be extended therethrough and fixedly secure the communication cable to prevent movement of the communication cable and provide strain relief and to retain the water pipe. The water pipe is kitted with a commercially available barbed fitting and a valve.

### ADD CLAIMS HERE AFTER INVENTOR APPROVAL

Additional features and advantages of the presently disclosed apparatus will become apparent to those skilled in the art upon consideration of the following detailed description.

### BRIEF DESCRIPTION OF THE DRAWINGS

The detailed description of the drawings particularly refers to the accompanying figures.

FIG. 1 illustrates a block diagram of an application environment of the disclosed adaptor apparatus examples according to some aspects of the present disclosure.

FIG. 2 illustrates plan and elevation/side views of an adapter apparatus according to certain aspects of the present disclosure.

FIG. 3 illustrates plan and elevation/side views of an insert as well as another insert used in the adapter apparatus of FIG. 2 according to certain aspects of the present disclosure.

FIG. 4 illustrates elevation/side and elevation/side sectional views of the adapter apparatus of FIG. 2 with the inserts of FIG. 3 inserted according to certain aspects of the present disclosure.

FIG. 5 illustrates a three-dimensional view of an example of the apparatus of FIGS. 1-4 along with a communication cable or wiring affixed therein according to certain aspects of the present disclosure.

FIG. 6 illustrates another three-dimensional view of the apparatus in FIG. 5 according to certain aspects of the present disclosure.

FIG. 7 illustrates side/elevation, side/elevation sectional, and trimetric views of another exemplary adapter apparatus according to certain aspects of the present disclosure.

FIG. 8 illustrates plan, elevation/side, and trimetric views of another exemplary adapter apparatus according to certain aspects of the present disclosure.

FIG. 9 illustrates plan, elevation/side sectional, and trimetric views of an insert used in the adapter apparatus of FIG. 8 according to certain aspects of the present disclosure.

FIG. 10 illustrates plan, elevation/side sectional, and trimetric views of another insert used with the adaptor of FIG. 8 according to certain aspects of the present disclosure.

FIG. 11 illustrates plan, elevation/side sectional, and trimetric views of a service pipe according to certain aspects of the present disclosure.

FIG. 12 illustrates a plan view of an exemplary lock collar according to certain aspects of the present disclosure.

FIG. 13 illustrates side and trimetric views of an example of the apparatus of FIG. 10 and FIG. 11 assembled together according to certain aspects of the present disclosure.

FIGS. 14A and 14B illustrate a trimetric view of an example of the apparatus illustrated by FIGS. 8-13 along with a communication cable or wiring and valve and barbed fitting affixed therein according to certain aspects of the present disclosure.

FIG. 15 illustrates a cutaway side view of the apparatus of FIGS. 14A and 14B according to certain aspects of the present disclosure.

### DETAILED DESCRIPTION

Embodiments or examples of the presently disclosed apparatus described herein are not intended to be exhaustive or to limit the present disclosure to the precise forms disclosed. Rather, the disclosed examples or embodiments have been chosen to enable one skilled in the art to practice the presently disclosed apparatus and concepts.

As further background of the presently disclosed apparatus, it is noted in the past, during emergency situations (such as a refrigerant leak or fire) on ships, obtaining pertinent information and data is obtained via a telephone line, thus precluding the capability of transferring real time, data. It is also noted that supplying services (such as water) to the spaced with closed environment would require opening a barrier to the closed environment to route this service. Accordingly, work had been done for several years to attempt to solve the problem of how to obtain live data from and/or supply services (such as water) to an isolated area following establishment of the closed environment, such as that created during a refrigerant leak or fire. The main problem was obtaining data from or supplying services (such as water) to an isolated area where strict controls of penetrations, hatches and valves exist. Isolation of certain areas is established following creation of the contained/sealed environment (such as release of a noxious gas). As vessels not only have few penetrations, but also very strict control of those penetrations, previous work attempts could not find an easy method to retrofit a new system on in-service ships.

Accordingly, a need existed for an apparatus or assembly affording transfer of signal information out of or for providing supply services (such as water) to sealed spaces on vessels that is quick to install and remove with minimal retest along with lower cost. The present disclosure provides an adaptor apparatus that capitalizes upon and utilizes componentry that is common to ships and thus led to the presently disclosed adaptor that provides a universal assembly/adaptor that may be utilized across many different vessels. In a particular aspect, the presently disclosed adaptor assembly affixes onto a fire-fighting thread that is common to vessels. The adapter affords data transfer from or supply services (such as water) to a sealed space of a ship, and also provides a high level of integrity, and allows data to pass from the sealed space via signal cable(s).

In further aspects, the presently disclosed apparatus may include a specially designed adapter apparatus that allows for the use of commercial off the shelf (COTS) signal cable(s) for effecting signaling/communication into and out of the sealed space and COTS fluid fixtures such as valves or barbed fittings to supply services (such as water), along with COTS epoxy applied to the adapter and cable in one exemplary assemblage to create a high integrity assembly. The assembly prevents unknown compounds from entering outside spaces while allowing transfer of live digital information or supply services (such as water) to from the isolated area to the open area.

Moreover, the adapter assemblies described herein are used as part of a live data transfer system that allows personnel to see live data from an isolated area, such as in the case of a sealed/closed event on a vessel. The adapter assembly also provides the capability to provide services (e.g., water) to the isolated area. The design criteria for the assembly (quick to install, quick to remove, minimal retest, location), made conceiving of the present designs extremely difficult.

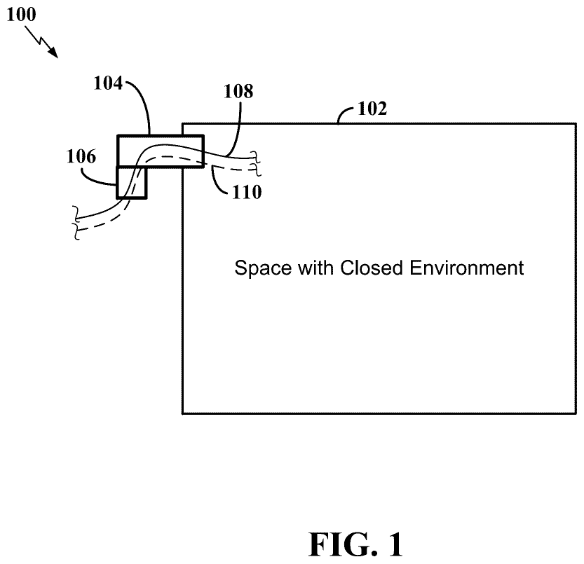

FIG. 1 illustrates a block diagram of system 100 comprised of an application environment of the disclosed adaptor apparatus examples according to some aspects of the present disclosure. As illustrated, an environmental space 102 such as a ship may have an existing penetration, aperture, or opening 104 allowing the ability to feed a communication cable there through between space 102 and the outside of space 102. In one example, the penetration 104 may consist of a piping penetration into the sealed environmental space of a ship. Moreover, the piping penetration may include a common male thread (not explicitly shown) capable of coupling with a female threaded fitting.

Furthermore, the system 100 includes an adaptor apparatus 106 that couples to the penetration 104 (and more particularly a male threaded fitting of the penetration 104 in one example). This adaptor apparatus 106 includes a center bore and various inserts, as will be described in more detail later, and allows a communication cable 108 and other conduit or pipe 110 (e.g., water supply) to pass there through from space 102 to outside of the space 102 for obtaining information and supplying services (such as water). As will be also further discussed, the adaptor apparatus 106 is configurable to be environmentally sealed with a sealant such as epoxy to maintain integrity and prevent leakage of the closed space within space 102.

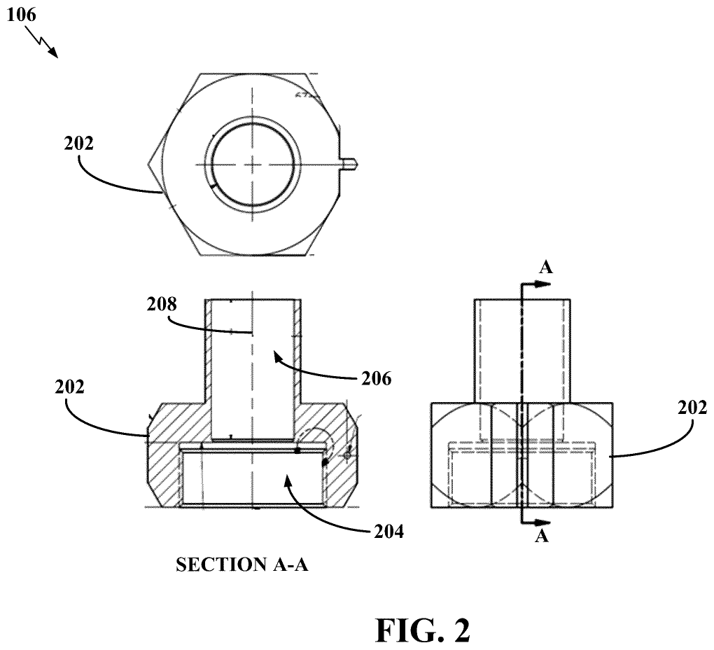

FIG. 2 illustrates plan, elevation/side, and elevation/side sectional views of at least a portion of the adapter apparatus 106 according to certain aspects of the present disclosure. As shown, the adaptor 106 is composed of a body 202 (or also referred to herein as an “adaptor body”), which may be one piece and constructed of any of a variety of materials such as metals, plastics, or carbon fiber. The body 202 includes a first inner bore section 204 of a first diameter extending centrally through the body 202 and having threads (not shown in this figure) The threads are configured for securement to an existing penetration or pipe (e.g., 104) into the environmental space (e.g., 102).

The body 202 further includes a second inner bore section 206 of a second diameter extending centrally through the body 202 and continuously connected (i.e., open to or continued) to the first inner bore section 204 such that first and second inner bore sections 204, 206 may be concentrically aligned on an axis 208 (although not necessarily limited to such alignment and may alternatively be offset as long as there remains a continuous passageway through the body 202) and allow passage of a communication cable (not shown in this figure) through the body 202. In some particular aspects, although not limited to such, the adapter body 202 may be constructed of stainless steel, which provides strength and the ability to mate with various epoxies, such as a COTS epoxy (e.g., 3M® GRAY 2216).

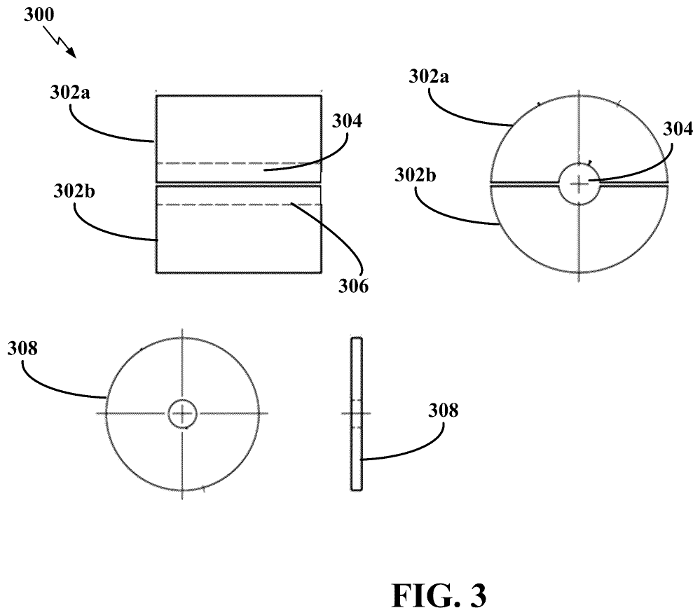

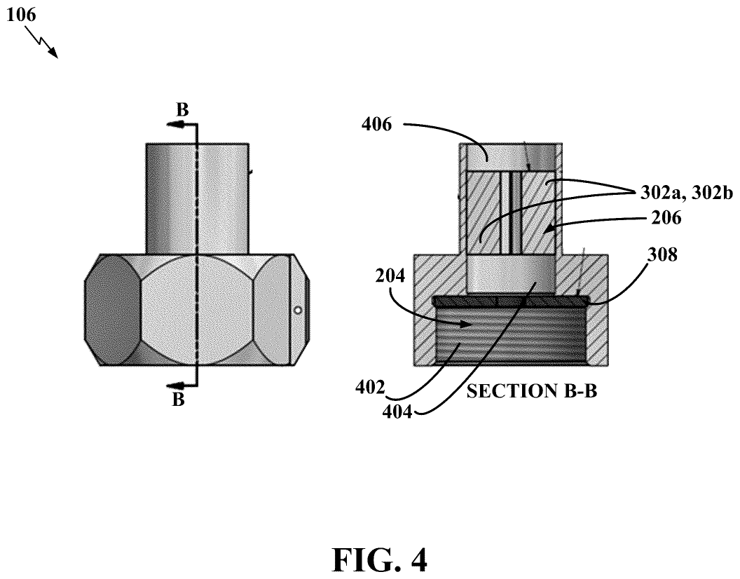

In some other aspects, the body 202 is configured with a 0.75″ section of 2.5 NH-7.5 TPI female thread pattern. This thread pattern is a common thread pattern for several known applications and affords installation on multiple many varieties of ships as firefighting capability is required on many vessels. The body 202 may also feature a small groove for a gasket (e.g., 308 to be discussed in FIG. 3) just inside of the threaded portion (e.g., 402 shown in FIG. 4). This gasket provides high strength and allows the adapter apparatus 106 to seal against a selected component.

Other features of the body 202 may include a 1.55″ THRU hole. This hole provides ample room for the selected signal cable(s) and their associated connector(s) to pass through with ease. Furthermore, the body may feature a 1.600″ by 2.7″ counter bore hole. The difference between the counter bore hole and the THRU hole is 0.05″. This provides a mechanical seating surface for the split inserts. The mechanical seating surface provides mechanical strength in the case of an epoxy failure. Moreover, the body may feature an exterior 3.50 AF Hex pattern. This hex pattern allows for installation using a common tool such as a pipe wrench. In some aspect, chamfers are provided on the hex patter (e.g., 30 Degree chamfers on the Hex pattern). These chamfers provide a means to protect the workers performing the installation. Still further, the body may feature a safety lock wire tab with a 0.125″ lock wire hole. The safety lock-wire tab is required to prevent inadvertent operation of the adapter apparatus 106. When installed, the lock wire will ensure that the adapter does not back off.

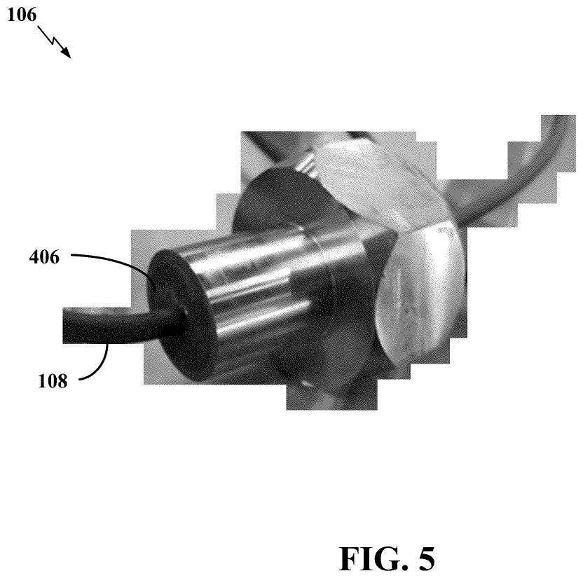

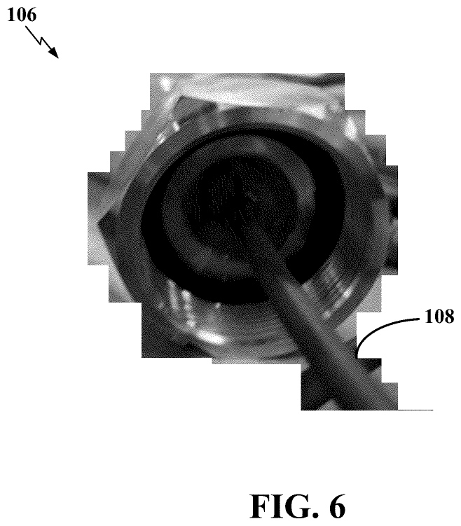

FIG. 3 illustrates a plan and elevation/side views of an insert 300 used in the adapter apparatus 106 of FIG. 2 according to certain aspects of the present disclosure. As illustrated, insert 300 may be configured, in one embodiment, to include two halves (i.e., a split insert or multiple inserts) 302a, 302b. Furthermore, each of the two halves 302a, 302b are configured with a half cylindrical cutout along an axial direction to define a cylindrical bore 304 extending centrally through the insert 300. This insert 300 (and bore 304 in particular) is further configured to allow a communication cable to be extended therethrough as will be illustrated in FIGS. 5 and 6.

In aspects, the insert 300 fixedly secures the communication cable to prevent movement of the communication cable and provide strain relief. It is further noted that in other aspects, the split insert 302a, 302b reduces the exposed hole to the approximate diameter of the communication cable(s). This reduction is advantageous as the cable(s) may be COTS products and may come with connectors already attached. This requires multiple diameters as the diameter of the connector is likely larger than the cable itself. When combined with a mechanical seating surface (See e.g., 404 in FIG. 4), this design feature provides mechanical strength against an acting differential pressure. The sealant (e.g., epoxy), which is shown in FIGS. 4-6, acts as a first barrier to a differential pressure, with the split inserts 302a, 302b and mechanical seating surface providing the second. According to still further aspects, the split insert material may be either aluminum or stainless steel, but is not necessarily limited to such.

In merely one specific embodiment, the split inserts 302a, 302b may be constructed with the following dimensions/characteristics: (1) a 0.380″ bore or thru hole that allows a ⅜″ cable to have a very small tolerance to the split inserts; (2) a 0.030″ split (See 306 in FIG. 3) or otherwise a split distance that is minimized for ease of assembly; (3) an outer diameter of 1.585″, which serves to minimize the distance between the split insert and a 1.600″ hole of the adapter 106; and (4) an overall length of 1.50″ that ensures an adequate balance between epoxy and metal (or other material) on the interior of the 1.600″ hole of the adapter 106.

FIG. 3 also illustrates another insert or rubber washer 308 that may be disposed m the first inner bore section 204, which helps exactly maintain the isolated environment when the adapter 106 is screwed onto the male threaded fitting of the penetration 104.

FIG. 4 illustrates elevation/side and elevation/side sectional views of the adapter apparatus of FIG. 2 with the insert of FIG. 3 inserted according to certain aspects of the present disclosure. As may be seen in this figure, the first inner bore section 204 include threads 402 of a predetermined thread pattern. In certain aspects, although not necessarily limited to such, the predetermined thread pattern selected will fit any 2.5 National Hose (NH)-7.5 Threads Per Inch (TPI) thread pattern. The threaded portion 402 of the adapter 106 (2.5 NH-7.5 TPI) is one important aspect of the presently disclosed design. Due to ship construction, retest implications, and safety concerns, an adapter would advantageously utilize this thread pattern for ships. However, the adapter 106 will work for any isolated area that utilizes this thread pattern, such as those buildings and vehicles that have firefighting capability.

Furthermore, FIG. 4 illustrates that the insert halves 302a, 302b may rest on a mechanical seating surface or block 404. This surface or block 404 may be constructed of metal or other suitable materials, or alternatively a sealant such as epoxy (e.g., 3M®2216 Gray) and is disposed on an upper surface of the rubber washer or insert 308. Moreover, at the top of the second inner bore section 206 above the inserts 302a, 302b is disposed a cap portion 406, which may be constructed of a sealant such as epoxy or other suitable sealant material that is intended to maintain a seal from the isolated space in the ship or other area (e.g. 102).

According to further aspects, it is noted that with small design changes, the split inserts 302a, 302b can be modified to accommodate various types of cables (power, fiber, signal, etc.). In further aspects, the split inserts 302a, 302b may be modified to account for additional cable(s). The split insert would then change from one ⅜″ center hole, to multiple holes. These holes would then have the approximate diameter of the selected cable. The split insert design will retain the same principle of reducing the exposed hole to the approximate diameter of the cable(s).

For assembling the adaptor 106, it is noted that the split inserts 302a, 302b may first be prepared for epoxy (such as 3M® 2216 Gray) by performing surface preparation. Next, the cable 108 is inserted into the 1.55″ thru hole of the adapter 106. The split inserts 302a, 302b are then placed inside of the 1.600″ hole until bottomed out on the mechanical stop 404. The split inserts 302a, 302b insert around the cable 108. Epoxy is used to mate all components together. In particular, epoxy fills the volume between the top of the split insert 302a, 302b and the front top face of the adapter to form the cap 406.

FIG. 5 illustrates a three-dimensional view of an example of the apparatus 106 of FIGS. 1-4 along with a communication cable or wiring affixed therein according to certain aspects of the present disclosure. As may be seen, the communication cable or wire 108 passes through the adapter 106. Furthermore, this view shows the sealant cap portion 406 in place above the inserts 302a, 302b and sealed around the cable 108.

FIG. 6 illustrates another three-dimensional view of the apparatus in FIG. 5 according to certain aspects of the present disclosure.

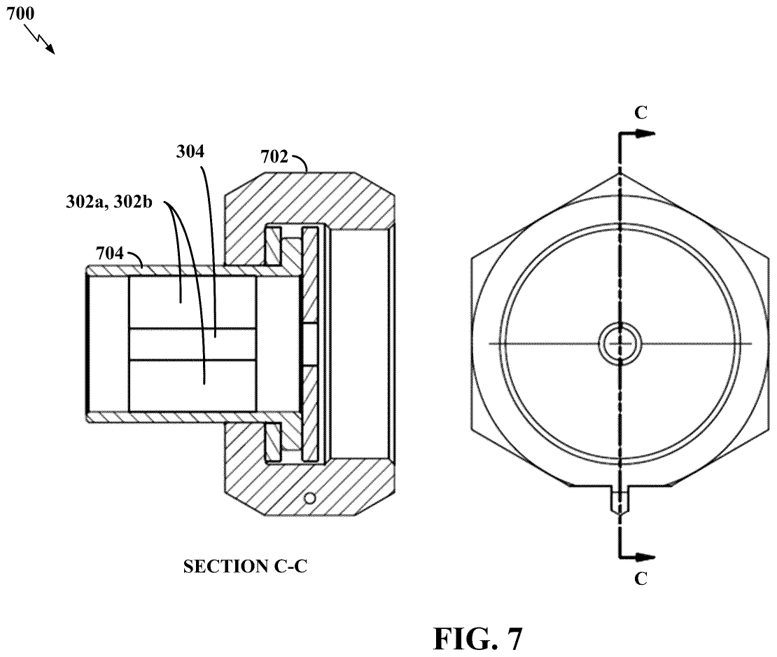

FIG. 7 illustrates a side/elevation view and a sectional view of another exemplary adapter apparatus 700 according to certain aspects of the present disclosure. In this example, the adapter 700 may be altered to include cable twist mitigation. This exemplary design includes a rotating collar 702 with the 2.5 NH-7.5 TPI thread pattern that moves relative to a second portion 704 containing the inserts 302a, 302b and bore 304 for the cable 108. As will be appreciated by those skilled in the art, the combination of the 2.5 NH-7.5 TPI threaded adapter with split inserts, epoxy and signal cable(s) provides a novel solution to affording transfer of signal information out of sealed spaces such as those within a ship that is quick to install and remove with minimal retest along with lower cost.

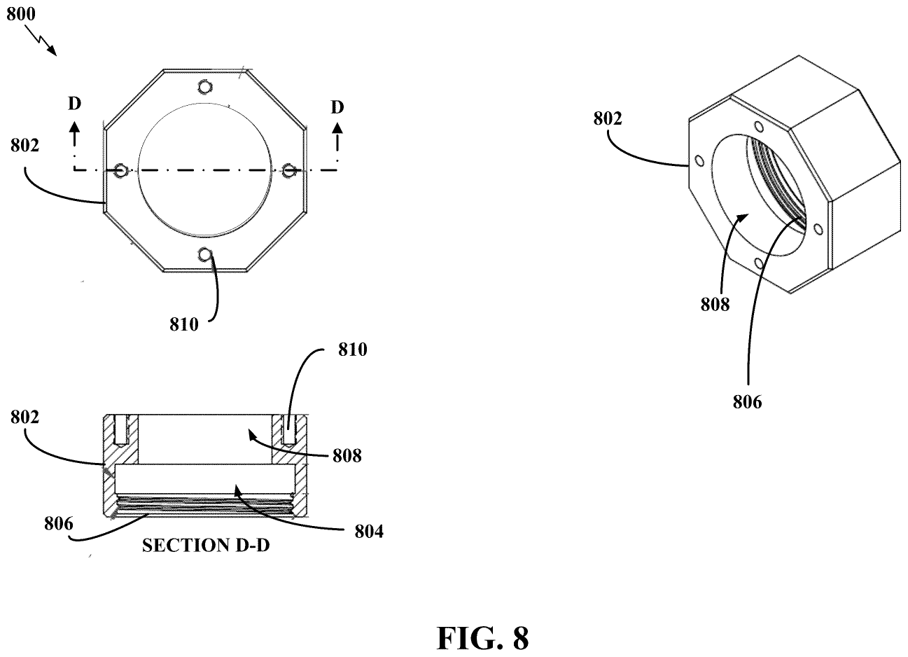

FIG. 8 illustrates plan, elevation/side sectional (Section D-D), and trimetric views of an adapter body 800 for another exemplary adapter apparatus that may embody the adapter 106 of FIG. 1 according to certain aspects of the present disclosure. As shown, the adaptor body 800 is composed of a body or nut portion 802, which may be one piece and constructed of any of a variety of material such as metals, plastics, or carbon fiber. The body portion 802 includes a first inner bore section 804 extending centrally through the body portion 802 and having threads 806. The threads 806 are configured for securement to an existing penetration (e.g., 104) of the environmental space (e.g., 102).

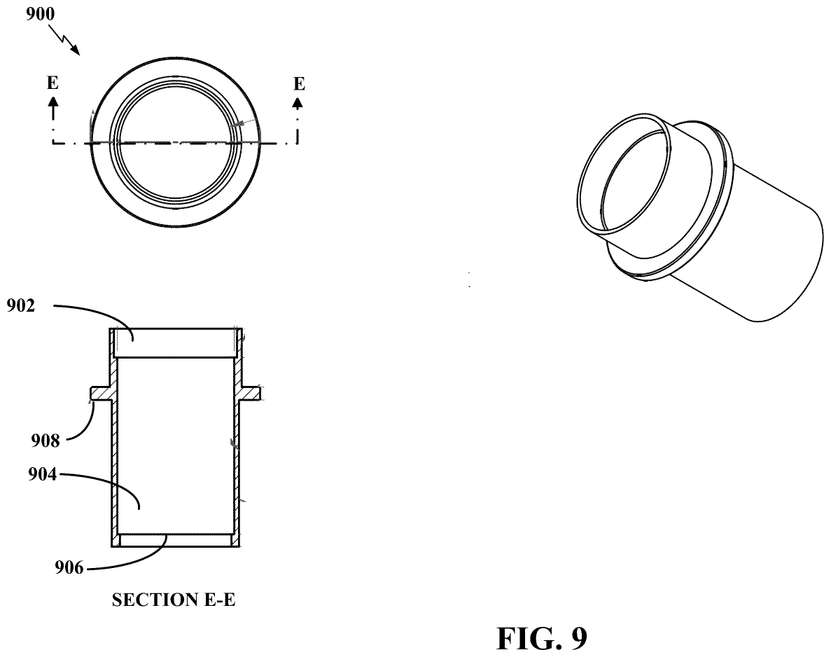

The body portion 802 further includes a second inner bore section 808 extending centrally through the body portion 808 and continuously connected (i.e., open to or continued) to the first inner bore section 804 such that first and second inner bore sections 804, 808 may be concentrically or coaxially aligned to allow passage of a threaded collar 900, which will be illustrated later with regard to FIG. 9, but is not necessarily limited to concentric or coaxial alignment. In some particular aspects, although not limited to such, the adapter body portion 802 may be constructed stainless steel, which provides strength and the ability to mate with various epoxies, such as the selected COTS epoxy (3M® GRAY 2216).

In yet other aspects, but not limited to such, the adapter body portion 802 may incorporate interior cuts: A ˜0.400″ section of 2.5 National Hose (NH)-7.5 threads per inch (TPI) female fire fighting thread pattern (e.g., threads 806). This threading pattern for threads 806 of the adapter body 802 may be configured for applications matching common thread patterns used for ships, as one example.

According some yet further aspects, it is noted that adapter body portion 802 may be configured with an exterior 3.50 AF Hex pattern. This hex pattern allows for installation using a common tool (such as a pipe wrench). The adapter body 800 cannot reasonably be installed by hand due to the required torque. Yet further, it is noted that the design may include chamfers on the Hex pattern (e.g., 45 degree chamfers). These chamfers provide a means to protect the workers performing the installation. Moreover, four ¼-20 countersunk holes 810 on a 2.900 diameter bolt circle for a COTS lockwire bolt may be provided, although not necessarily limited to such a diameter or thread pattern and may alternatively be different if there remains at least one countersunk threaded hole.

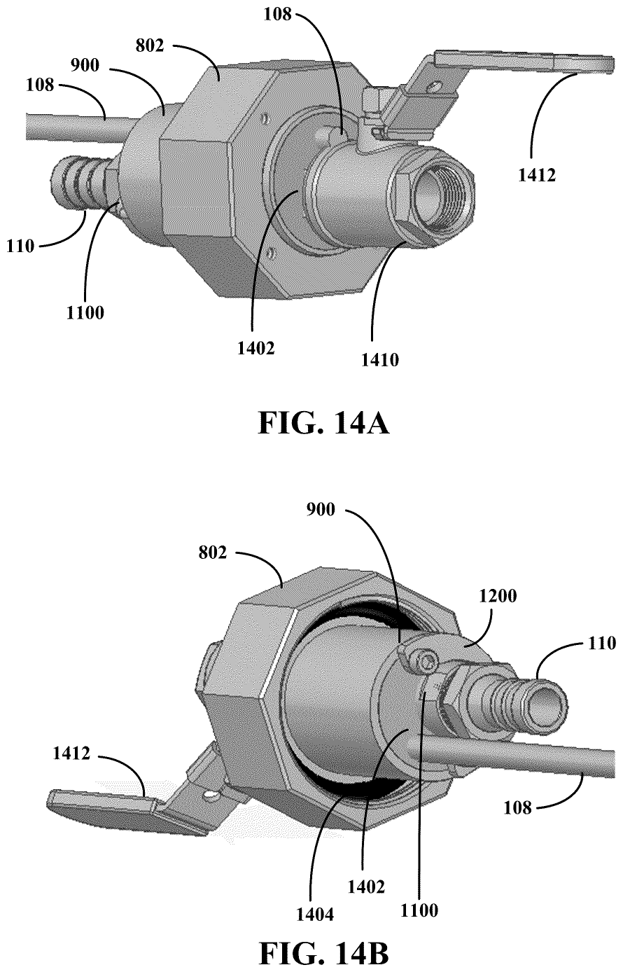

FIG. 9 illustrates plan, elevation/side sectional (Section E-E), and trimetric views of a threaded collar 900 used in the adapter apparatus 106 with the adaptor body portion 800 of FIG. 8 according to certain aspects of the present disclosure. According to still further aspects, the threaded collar material may be either aluminum or stainless steel but is not necessarily limited to such. The threaded collar 900 may incorporate the various features illustrated in FIG. 9. In particular, the collar 900 may include a counterbore hole 902 dimensioned to allow ample room for a COTS flow valve (e.g., flow valve 1410 shown in FIGS. 14A and 14B that mates with threads on the service pipe 1100) when installed with a service pipe (e.g., 1100) as will be illustrated in FIGS. 14A and 14B.

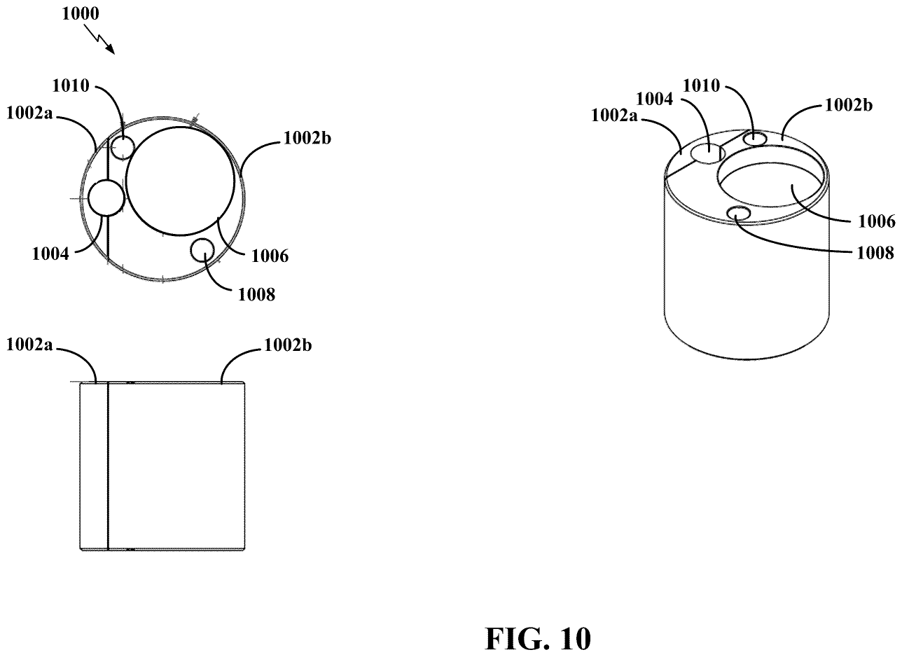

Additionally, collar 900 may include a counterbore hole 904 having a predetermined depth (e.g., 3.50″). The counterbore hole 904 provides a mechanical seating surface for split inserts, which will be illustrated in FIG. 10. The mechanical seating surface provides mechanical strength in the case of an epoxy failure (if epoxy is used), for example.

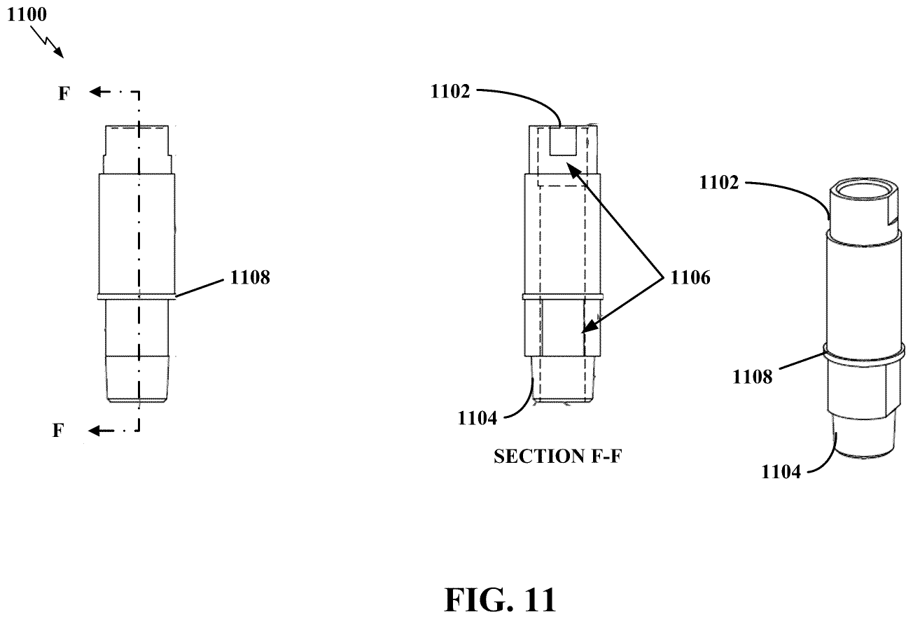

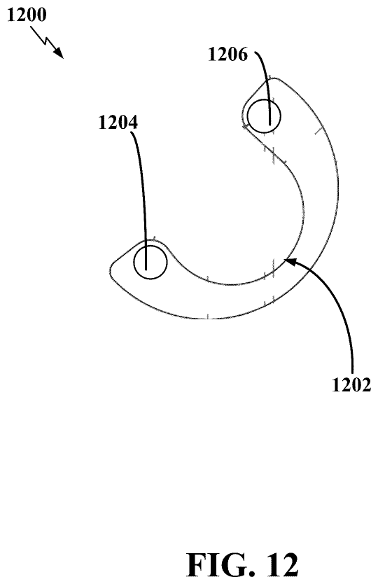

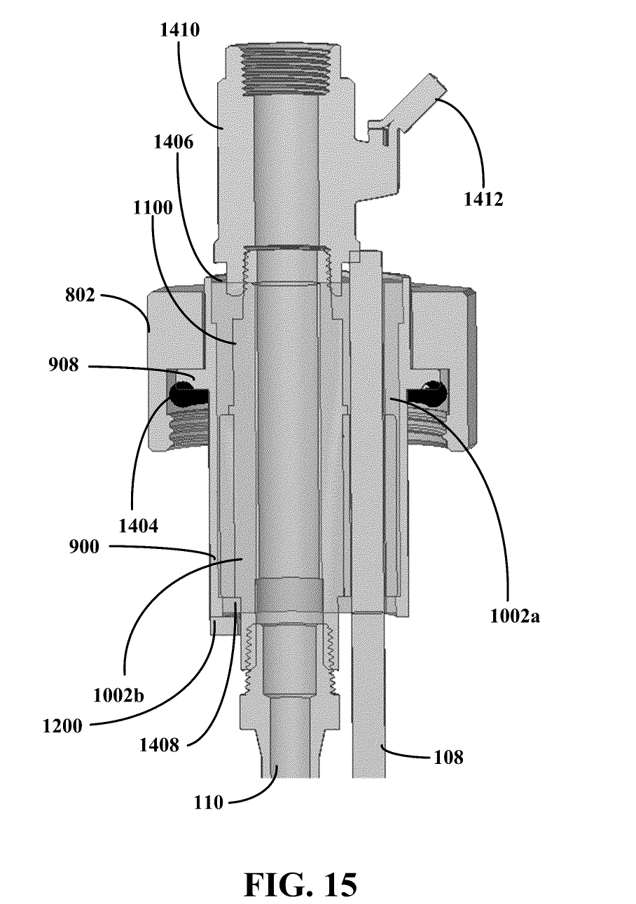

Other design aspects of the threaded collar 900 may include a sufficient outer diameter (e.g., 2.175″) to prevent interference when installed into the penetration 104. Further, collar 900 may include a thru hole or aperture 906. This hole 906 provides room for the communication cable(s) connectors(s) and the split inserts of FIG. 10, as well as a service pipe apparatus as illustrated in FIG. 11 and FIG. 12. Yet further aspects include a threaded collar 908 with 2.5 NH-7.5 TPI male fire fighting threads in one example. This allows the threaded collar 900 to be installed into adapter body 802. In still further aspects, the threaded collar 900 affords the ability for the total assembly (See e.g., FIGS. 14 and 15) absent the adaptor body 800 to be placed in the penetration 104 and then the adaptor body 800 to be screwed down and secured on threads of the penetration 104 such that torsion or rotation of remainder of the assembly is mitigated or even totally prevented, thereby avoiding twisting of the communication cable (e.g., 108).

FIG. 10 illustrates plan, elevation/side, and trimetric views of an apparatus 1000 including two respective split inserts 1002a and 1002b (which collectively may also be referred to as “an insert” when disposed within threaded collar 900). Each of the two inserts 1002a and 1002b are configured with a cylindrical cutout along an axial direction to define at least one (i.e., a first) bore 1004 extending through inserts 1002a and 1002b, which may be cylindrical as illustrated but not necessarily limited to such. Bore 1004 is configured to allow a communication cable to be extended therethrough as will be seen in FIGS. 14A and 14B.

In aspects, the respective first and second inserts 1002a and 1002b fixedly secure the communication cable to prevent movement of the communication cable and provide strain relief. In other aspects, split insert 1002b is configured with another second bore or through hole 1006 to permit a press fit with service pipe 1100 as illustrated in FIG. 11 and the pipe 110 to extend therethrough.

It is further noted that in other aspects, the split inserts 1002a and 1002b reduce the exposed hole to the approximate diameter of the communication cable(s). This reduction is advantageous as the cable(s) are COTS products and may come with connectors already attached. This requires multiple diameters as the diameter of the connector is likely larger than the cable itself. When combined with a mechanical seating surface (See e.g., 904 in FIG. 9), this design feature provides mechanical strength against an acting differential pressure. A sealant 1402 (e.g., epoxy), which is shown in FIGS. 14A and 14B, acts as a first barrier to differential pressure, with the split inserts 1002a and 1002b and mechanical seating surface providing the second.

According to still further aspects, the split insert material may be either aluminum or stainless steel but is not necessarily limited to such. In merely one specific embodiment, the split inserts 1002a and 1002b may be constructed with the following dimensions/characteristics: (1) a 0.400″ bore 304 or thru hole that allows a ⅜″ cable to have a very small tolerance to the split inserts; (2) a 0.011″ split or otherwise a split distance that is minimized for ease of assembly; (3) an outer diameter of 1.950″, which serves to minimize the distance between the split insert and the 2.000″ hole of the threaded collar 900; and (4) an overall length of 2.00″ that ensures an adequate balance between epoxy and metal (or other material) on the interior of the 2.000″ hole of the threaded collar 900. The split insert 1002b is configured with two thru holes 1008 and 1010 for installation of a COTS ¼-20 threaded insert. The threaded insert is used to mate the split insert 302b to a lock collar 1200 with a COTS fastener during assembly of the adapter 106 as illustrated in FIGS. 12 and 14A, 14B and 15.

FIG. 11 illustrates elevation/side. elevation/side sectional (Section F-F) and trimetric views of a service pipe 1100. The service pipe 1100 may be configured to include female threads 1102 (e.g., ¾-14 female NPT thread) and male threads 1104 (e.g., ¾-14 male NPT thread) to permit mating of a COTS barbed fitting (e.g., a fitting configured to couple with a water line within the isolated space) and COTS flow valve, respectively. Flats 1106 are included to permit ease of installation of the COTS barbed fitting and COTS flow valve. Also illustrated in FIG. 11 is mechanical stop 1108 which is used to provide ease of assembly when pressing service pipe 1100 into split insert 1002b as illustrated in FIG. 10. According to still further aspects, the service pipe material may be either aluminum or stainless steel but is not necessarily limited to such.

FIG. 12 illustrates plan and side/elevation views of a lock collar 1200 according to aspects of the present disclosure. The lock collar 1200 may be configured with a cutout 1202 configured to allow a slip fit with service pipe 1100 when adapter 106 is assembled as illustrated in FIGS. 14A, 14B. Fastening split insert 1002b to lock collar 1200 via the holes 1204, 1206 corresponding to holes 1008, 1010 ensures that the service pipe assembly 1100 does not move when epoxy 1402 is installed as illustrated in FIGS. 14A, 14B. According to still further aspects, the lock collar material may be either aluminum or stainless steel but is not necessarily limited to such.

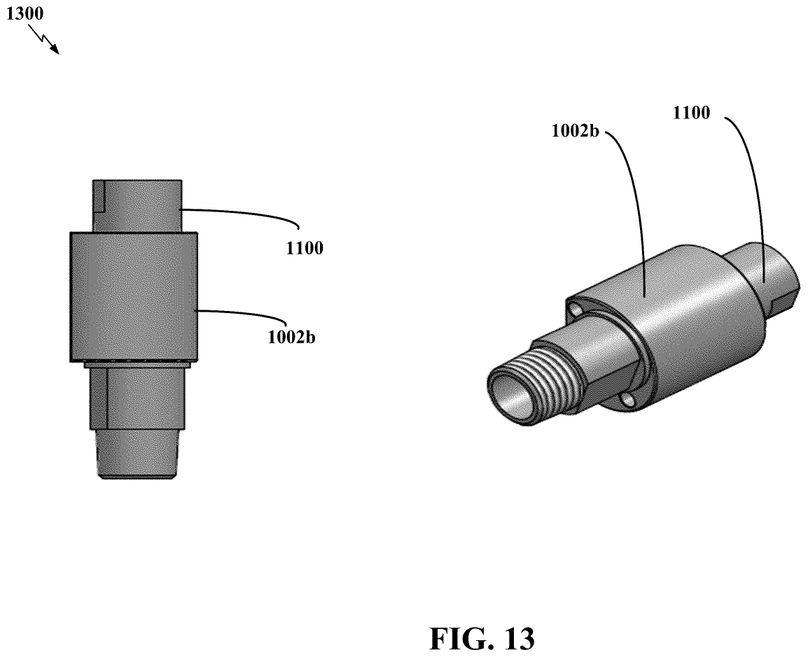

FIG. 13 illustrates side and trimetric views of the assembly 1300 of service pipe 1100 and split insert 1002b. This assembly is executed by executing a press fit of service pipe 1100 into a thru hole 1006 of split insert 1002b.

FIGS. 14A and 14B illustrates a trimetric view of the assembled adapter assembly 106. It is noted that the communication cable 108 is not shown with a connector. Also, it is noted that during manufacturing, communication cable 108 will be pulled away from the COTS valve such that the interference seen in these figures does not occur. During manufacturing of the adapter assembly 106, sealant 1402 such as epoxy (e.g., 3 M® 2216 Gray) is applied in two iterations. The first iteration is applied on the valve side, the second is on the barbed fitting side. Sealant is applied to prevent leakage from the isolated space in the sealed area 102 as shown in the three-dimensional sectional view of adapter assembly 106.

FIG. 14B also illustrates an O-ring 1404 that may be disposed in the first inner bore section 804, which helps prevent environmental leakage when the adapter 106 is screwed onto the male threaded fitting of the penetration 104. Moreover, in one example a COTS value 1410 may be fitted onto

For assembling the adaptor 106, which is illustrated in FIG. 15 in final assembly, it is noted that the threaded collar 900, split inserts 1002a, 1002b and service pipe 1100 may first be prepared for epoxy (such as 3 M® 2216 Gray) by performing surface preparation. Next, the cable 108 is inserted into the 1.900″ thru hole of the threaded collar 900. Next, the service pipe assembly 1100 is installed into the threaded collar until bottomed out. The lock collar 1200 is then installed around the service pipe 1100. COTS fasteners are then used to tighten the split insert 1002b to the threaded collar. The split insert 1002a, is then installed inside of the 1.900″ hole until bottomed out on the mechanical stop. Epoxy is used to mate all components together. In particular, epoxy fills the volume between the top of the split inserts 1002a, 1002b and the front top face of the adapter to form 1406. Once cured, the adapter 106 is then flipped and epoxy is then used to mate the bottom of split inserts 1002a and 1002b and threaded collar to form the bottom cap 1408.

As mentioned above, ultrasonic transmitters and receivers may provide an alternative to using an existing hull penetration. However, the cost of an ultrasonic assembly is much greater than the presently disclosed adaptor and also takes significantly more time to install at around 24 hours when compared to the present adapter, which takes approximately 1 hour to install.

The adapter assembly described herein is used as part of a live data transfer system that allows personnel to see live data from an isolated area, such as in the case of a sealed/closed event on a vessel. Furthermore, the adapter assembly also provides the capability to provide services to the isolated area. It is noted that the design criteria for the assembly (e.g., quick to install, quick to remove, minimal retest, location, etc.) made design and engineering of the presently disclosed apparatus difficult.

Although the presently disclosed apparatus has been described in detail with reference to certain examples or embodiments, variations and modifications exist within the spirit and scope of the presently disclosed examples as described and defined in the following claims.

1. An adaptor for use in data transfer to or from an isolated space to an open or outside space while preventing hazardous constituents from transferring from the isolated area to the open area comprising:
a body comprising:
an inner bore section extending centrally through the body and having threads configured for securement to an existing penetration of the closed space; and
a second inner bore section extending centrally through the body and continuously connected to the first inner bore section such that first and second inner bore sections are axially aligned and allow passage of a communication cable through the body; and
an insert that is configured to be disposed into the body and is configured with a cylindrical bore extending centrally through the insert and configured to allow the communication cable to be extended therethrough and fixedly secure the communication cable to prevent movement of the communication cable and provide strain relief and to allow a service pipe to penetrate through the body.

2. The adaptor as defined in claim 1, further comprising:
the insert further disposed within the second inner bore section of the body.

3. The adaptor as defined in claim 1, further comprising:
a mechanical seating block disposed within the second inner bore section and in contact with a first surface of the insert.

4. The adaptor as defined in claim 3, wherein the mechanical seating block is comprised of one of metal or epoxy.

5. The adaptor as defined in claim 1, further comprising:
a cap portion comprised of epoxy and disposed within the second inner bore section and in contact with a second surface of the insert.

6. An adaptor for use in at least the transfer of information between an isolated space and an open space outside the isolated while preventing hazardous constituents from transferring from the isolated space to the open space comprising:
a body comprising an inner bore section extending centrally through the body and having threads configured for securement to an existing penetration of the isolated space;
a threaded collar configured to engage with the threads of the body and configured to be secured to the body; and
at least one insert configured to be disposed within the threaded collar and configured with at least one first bore extending through the insert and configured to allow a communication cable for information transfer to be extended therethrough and fixedly secure the communication cable to prevent movement of the communication cable and provide strain relief.

7. The adaptor as defined in claim 6, wherein the at least one insert comprises first and second split inserts that are configured to be inserted within the threaded collar to define the at least one insert.

8. The adaptor as defined in claim 6, further comprising:
at least one of the first and second split inserts further including a second bore configure to allow a service pipe to penetrate therethrough and further through the body.

9. The adaptor as defined in claim 8, wherein the service pipe is configured to supply water therethrough.

10. The adaptor as defined in claim 8, wherein the service pipe includes threads configured to mate with a flow valve.

11. The adaptor as defined in claim 8, wherein service pipe includes a barbed fitting configured to couple with a water line within the isolated space.

12. An adaptor for use in at least the transfer of information and services between an isolated space and an open space outside the isolated while preventing hazardous constituents from transferring from the isolated space to the open space comprising:
a body comprising an inner bore section extending centrally through the body and having threads configured for securement to an existing penetration of the isolated space;
a threaded collar configured to engage with the threads of the body and configured to be secured to the body; and
at least one insert configured to be disposed within the threaded collar and configured with a first bore extending through the insert and configured to allow a communication cable for information transfer to be extended therethrough and fixedly secure the communication cable to prevent movement of the communication cable and provide strain relief and a second bore extending through the insert and configured to allow a service pipe configured to providing services to the isolated space to extend therethrough.

13. The adaptor as defined in claim 12, wherein the at least one insert comprises first and second split inserts that are configured to be inserted within the threaded collar to define the at least one insert.

14. The adaptor as defined in claim 13, further comprising a locking collar configured to be affixed to both the first and second split inserts to hold the first and second inserts together to form the at least one insert.

15. The adaptor as defined in claim 12, wherein the service pipe is configured to supply water therethrough.

16. The adaptor as defined in claim 12, wherein the service pipe includes threads configured to mate with a flow valve.

17. The adaptor as defined in claim 12, wherein service pipe includes a barbed fitting configured to couple with a water line within the isolated space.
